(19) United States
(12) Patent Application Publication
(10) Pub. No.: US 2004/0025408 A1
(43) Pub. Date: Feb. 12, 2004

(54) De-hooking device for releasing fish

(76) Inventor: Michael L. Newman SR., Spring, TX (US)

Correspondence Address: JAMES L. JACKSON, ANDREWS & KURTH, L.L.P., 600 TRAVIS, SUITE 4200, HOUSTON, TX, 77002, US

(21) Appl. No.: 10/618,406

(22) Filed: Jul. 10, 2003

Related U.S. Application Data
(60) Provisional application No. 60/396,183, filed on Jul. 15, 2002.

(51) Int. Cl. A01K 97/00

(52) U.S. Cl. 43/53.5

(57) ABSTRACT

A de-hooking device for releasing fish from a fish hook at the end of a fishing line, without necessitating touching of the fish by the user. A handle structure is provided with a pivot to support a de-hooking element for pivotal movement to an open position essentially aligned with the handle and a closed position where the de-hooking element is located within a storage slot defined by the handle. The de-hooking element has an elongated substantially straight shank section having a tightly bent loop at the end opposite its pivot and a substantially straight terminal section of substantial length extending from the loop and lying in spaced relation with and extending a substantial distance along the elongated substantially straight shank section and defining an elongate narrow gap therewith. The terminal section has a flared terminal end oriented in angular relation with straight terminal section and defining a guide for guiding fishing line or the shank of a fish hook into the narrow gap.

### CROSS REFERENCE TO RELATED APPLICATION

Applicant hereby claims priority from Provisional Application No. 60/396,183, filed on Jul. 15, 2002 by Michael L. Newman and entitled “De-hooking Device For releasing Fish”, which Provisional Application is incorporated herein by reference for all purposes.

### BACKGROUND OF THE INVENTION

1. Field of the Invention

The present invention relates generally to fishing activities, typically recreational fishing where fish are caught, using a fish-hook tied to a fishing line, with bait being positioned on the fish-hook for attracting fish. More particularly, the present invention concerns apparatus, generally referred to as de-hooking apparatus, to enable fish that are caught to be simply and efficiently removed from a fish-hook, without necessitating touching of the fish during de-hooking.

2. Description of the Prior Art

It has long been desired to provide a tool for removing caught fish from fishing hooks, without necessitating touching the fish. In many cases, the person catching a fish simply does not want the slime that is present on virtually all fish to get on the person's hands, thus requiring washing or wiping of the hands to facilitate further fishing activities. In many cases, to ensure that caught and released fish will survive, it is desirable to ensure against contact of the fish by the hands of a fisherman. Often times the hands of a fisherman are coated with foreign substances, such as oils, sun creams and the like, which contaminate and be hazardous to the health of a fish that is to be released. In other cases, some fish have sharp teeth or fins that can inflict painful injury to a fisherman, thus it is desirable to provide a means for quickly and efficiently releasing the fish, without requiring touching it with the hands and thus providing protection against injury for the fisherman.

A number of de-hooking tools have been developed, as is evident from U.S. Pat. No. 2,289,767 of Ford; U.S. Pat. No. 2,724,207 of Miller et. al; U.S. Pat. No. 3,706,154 of Luebbers et. al; U.S. Pat. No. 3,888,038 of Howell; U.S. Pat. No. 4,914,853 of Swindle; U.S. Pat. No. 4,127,957 of Bourquin et al and Design Patent No. 362,898 of Krupp.

### SUMMARY OF THE INVENTION

It is a principal feature of the present invention to provide a novel de-hooking device that is brought into operative engagement with a fishing line and fish hook and then manipulated with a flipping action to extract a fish-hook from the mouth of a caught fish, thereby allowing the fish to fall free of the hook for deposit into a receptacle for keeping or to fall into the water if releasing of the fish is desired;

It is also a feature of the present invention to provide a novel fish de-hooking device that is capable of being folded or extended in the manner of folding or extending a pocket knife, thereby providing for use of the apparatus for de-hooking a fish or providing for efficient storage of the device in a tackle box or other such storage device for fishing equipment;

It is another feature of the present invention to provide a novel fish de-hooking device that is capable of being supported on the belt or clothing of a user in readiness for use or supported on the belt or clothing of the user by a lanyard, D-ring, or clip device so that it can be quickly and efficiently readied for use to de-hook a fish from a fish-hook, without necessitating contact of the fish by the hands of the user.

Briefly, the various objects and features of the present invention are realized by providing a fish de-hooking device having a handle that is designed for efficient gripping by the hand of a user. An elongate de-hooking element, which may be composed of wire, such as stainless steel wire or plated wire or which may be composed of a substantially rigid polymer material, is connected to the handle by a pivot, such as a screw or rivet. The elongate de-hooking element defines an elongate shank of substantially straight configuration, which has a tightly bent loop at its free end, opposite the pivot connection, with a substantially straight end section thereof folded back along the elongate shank and being spaced from the shank. Spacing of the substantially straight end section from the elongate, substantially straight shank defines an elongate substantially straight and narrow slot or gap that is enabled to receive the fishing line and or the shank of a fishing-hook. The free terminal end of the substantially straight end section is flared or angulated away from the elongate, substantially straight shank and defines a guide end which permits a fishing line or the shank of a fishing hook to be guided into the elongate slot and moved to the tightly bent loop.

During use of the de-hooking device the shank of the fishing-hook is engaged within the elongate narrow slot or gap and is moved along the slot until the tightly bent loop moves essentially into contact with the curved end of the fish-hook, relatively close to the barb of the hook. At this point the tightly bent loop portion of the de-hooking element will be essentially within the mouth of the fish. By pulling with a moderate force on the fishing line with one hand and pulling on the handle of the de-hooking device with the other hand and holding the fishing line and de-hooking element essentially horizontally, the fish is flipped toward the user and over the horizontal, which action causes the barb of the hook to be extracted from the mouth of the fish, with minimal damage to the mouth tissues of the fish. The fish will thus fall free of the hook and can fall into a receptacle for keeping if desired or will fall back into the water, depending on the manner by which the de-hooking device is positioned during use. The de-hooking device can be pivotally folded for storage or pivotally extended for use as desired.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a side elevational view showing a de-hooking device for releasing fish from fishhooks according to the principles of the present invention and employing the features of the present invention and showing the pivotal hook engaging element thereof extended to the position for fishing line and hook engagement;

FIG. 2 is a side elevational view similar to that of FIG. 1 and showing the pivotal de-hooking element thereof in its folded or closed condition such as for storage;

FIG. 3 is a side elevational view of the handle structure of the de-hooking device of the present invention.

FIG. 4 is a front elevational view of the fish de-hooking device, showing the pivotal hook engaging element thereof shown at its open or extended position in readiness for use and showing the storage slot of the handle for receiving the pivotal hook engaging element in the folded or closed position thereof; and

FIG. 5 is a side elevational view of the fish de-hooking device of the present invention and showing the elongate pivotally mounted de-hooking element thereof located at an intermediate position such as during pivotal extension or pivotal folding of the pivotal hook engaging element thereof.

### DETAILED DESCRIPTION OF PREFERRED EMBODIMENT

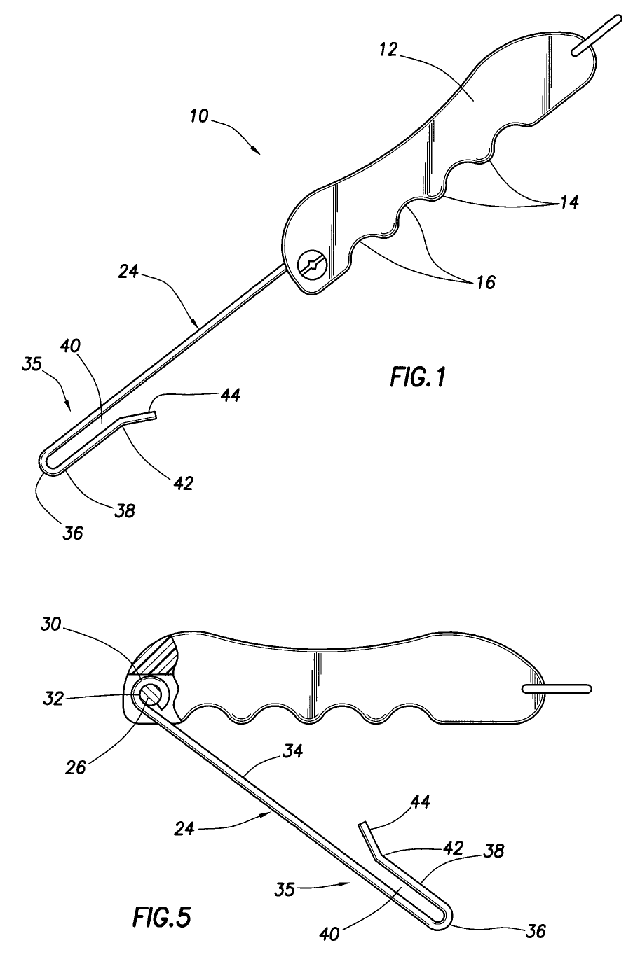

Referring now to the drawings and first to FIG. 1, a de-hooking device embodying the principles of the present invention is shown generally at 10 and incorporates a handle structure 12 which defines a plurality of curved ridges 14 and grooves or depressions 16 which together define a handle portion that received the fingers of a user and thus renders the handle to a configuration for efficient gripping. The handle 12 is typically of the dimension of a large pocket knife so that the de-hooking device may be folded to a dimension and configuration for ease of storage in the tackle box or other storage unit of a fisherman. Preferably, the handle structure is molded or otherwise formed so as to be an integral handle unit to which a fish de-hooking element is pivotally or otherwise attached.

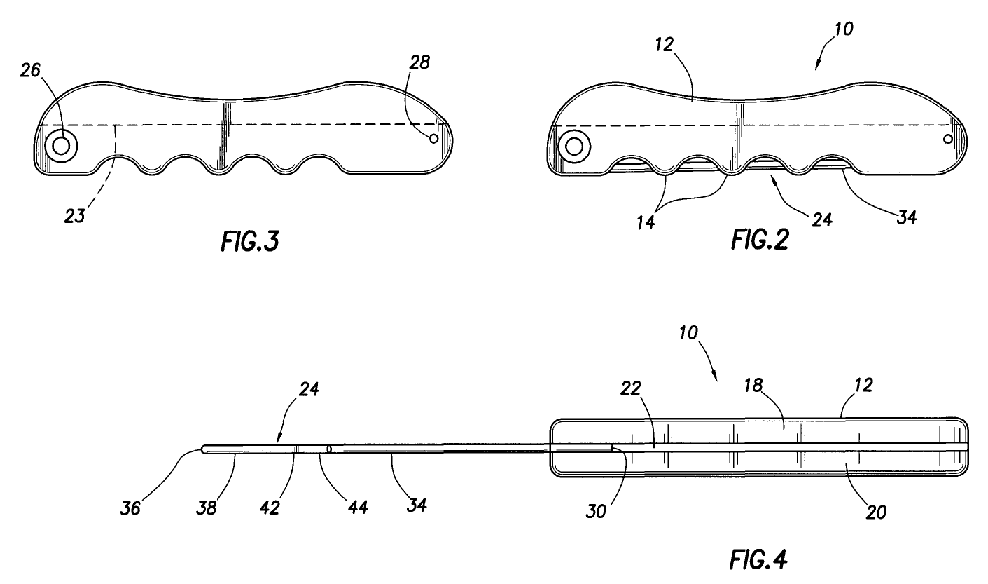

The elongate handle structure 12, as shown in detail in FIGS. 2 and 3, has a pair of side plates or scales 18 and 20 which are spaced from one another so as to define a storage slot or groove 22 into which an integral de-hooking element, shown generally at 24, may be pivotally moved, such as for storage. The extent of the depth and length of the elongate slot or groove 22 of the elongate handle structure 12 is indicated by reference numeral 23 in FIGS. 2 and 3 by means of broken lines 23 which identify the bottom surface of the elongate slot or groove. The bottom surface 23 of the slot forms a stop surface for the de-hooking element so that the de-hooking element will not pivot further from the FIG. 1 position thereof. If desired, the handle structure 12 may be an integral unit that is molded or otherwise formed from a polymer material such as polypropylene. This integral type of handle structure is preferable. Regardless of the construction of the de-hooking device or tool, it is intended that the device be capable of floating in water. Thus, if the tool is dropped into the water or inadvertently becomes separated from a user that might be wading in the water, it will float and can be easily retrieved. In the alternative, the handle structure may be defined by handle plates or scales that are maintained in spaced relation by means of spacers therebetween. The plates or scales and spacers may be held in assembly by rivets, screws or any other suitable means of attachment.

At one end of the handle structure a pivot opening or receptacle is defined which is oriented in substantially normal relation with the elongate slot and receives a pivot element 26 serving as a pivot mount for an essentially circular pivotal end of the pivotal de-hooking element 24. This pivotal mounting of a pivot end of the integral de-hooking element, thus allows the pivotal de-hooking element to be rotated about the pivot from a closed or stored position, where it is substantially entirely located within the elongate slot or recess 22, to an extended position for use, where it is oriented in extended alignment with the elongate handle, as is shown in FIG. 1. The bottom surface 23 of the handle slot 22 defines a stop surface to prevent further pivotal movement of the de-hooking element after it has been pivotally moved to the fully open position of FIG. 1.

FIG. 4 illustrates an intermediate position of the integral de-hooking element, such as during pivotal movement toward its open or extended position or toward its closed or stored position within the elongate storage slot or recess 22 of the handle structure. At the opposite end of the handle structure there is provided an opening 28 which may receive a lanyard or support ring, such as a D-ring or other connector by which the de-hooking device can be supported such as on the belt or clothing of a user in readiness for use. It should also be borne in mind that the fish de-hooking device can be supported from the waist belt of a user, as is described below. When the handle structure is defined by plates or scales that are secured in assembly, the hole 28 may receive a rivet or other securing element for securing one end of the handle structure in assembly.

The de-hooking element 24 may be composed of wire material of annular or circular cross-section, such as stainless steel, if desired and defines a generally circular pivot end 30 defining a pivot opening 32 through which the pivot element 26 extends. The de-hooking element 24 may also be composed of plated metal wire material or may be coated with any suitable material that resists rust and corrosion when exposed to water, especially salt water. The elongate de-hooking element may also be composed of any of a number of suitable non-metal materials, such as a substantially rigid polymer, if desired. Preferably, the integral de-hooking element is composed of a material, such as wire, having a circular or annular cross-sectional configuration. However, materials of other cross-sectional configuration may be employed that ensure against cutting or abrasion of fishing line during use of the device. The de-hooking element 24 defines a pivot end which may be defined by simply rolling wire material to a circular configuration, defining a circular pivot connection 30 having a central pivot opening 32, as best shown in FIG. 5. The elongate slot 22, whether the handle structure is of integral construction or is composed of an assembly of handle scales, as is typical of knife construction, defines a central space at a pivot end of the handle structure, which is defined by the elongate slot. A pivot receptacle, being essentially a transverse bore or passage receiving a pivot member that extends through the central pivot opening 32 and thus retains the circular pivot connection end 30 for pivotal movement within an end portion of the elongate slot. The pivot connection end 30 of the integral de-hooking element frictionally engages the opposed surfaces of the elongate slot and provides sufficient resistance to pivotal movement that the integral de-hooking element readily remains at any selected position, including full open, closed or stored and any position therebetween.

From the circular pivot connection end 30 the de-hooking element 24 has an elongate, substantially straight shank section 34, which defines an operating end shown generally at 35 having a tightly bent loop 36 of U-shaped configuration, with a substantially straight end section 38 extending from the tightly bent loop 36 and oriented so as to lie in substantially parallel relation or at a slight angular relation with the substantially straight section 34 and being in closely spaced relation with the shank section and thus defining a narrow elongate gap or slot 40. Preferably, the elongate slot has a width of about ⅛ inch but the slot may have a width of from about ¼ inch to about 1/16 inch. The length of the substantially straight end section 38 is about 1⅞ inches and together with the tightly bent loop 36 has an overall length of about 2⅛ inches. The substantially straight and angulated end section 44 has a length of about ½ inch. It is important that the substantially straight end section 38 be of substantial length with respect to the length of the substantially straight shank section. For example, when a de-hooking tool is provided according to the teachings of the present invention, and the substantially straight shank section 34 of the de-hooking element 24 may have a length of about 5½ inches from the handle to the tightly bent loop or an overall length of about 6¼ inches, including the tightly bent loop and the generally circular pivot, and the substantially straight end section 38 may have a length of about 2 inches from the U-shaped loop to the bend 42. Thus, the operating end 35 will have a length of from about ⅓ to about ½ of the over all length of the de-hooking element 24. Of course, the lengths specified above can vary without departing from the spirit and scope of the present invention, it being desirable that the operating end shown generally at 35 will be of considerable length. This feature is provided, so that for deeply hooked fish, a substantial portion of the shank and the substantially straight end section can be inserted deeply into the mouth of the fish to bring the U-shaped loop 36 into contact with the curvature of the typically U-shaped throat of a deeply embedded hook to a point near the barb of the hook. Thus, when the fishing line is pulled taut, with the tightly bent loop 36 properly placed with respect to the throat and barb of the hook, as explained in the section of this specification entitled “Operation”, when the fish is flipped toward the user and over the generally horizontally oriented fishing line and de-hooking tool, the barb of the hook is extracted from the mouth or throat tissue of the fish, with minimal damage to the tissue. There is no significant amount of tearing of the throat and mouth tissue of the fish as is the case with other “hook type” fish de-hooking tools that have been developed. Though the present invention will de-hook fish that have been caught with treble hooks, it works best when de-hooking single barb hooks from fish. For this reason, the de-hooking tool of the present invention is intended to be used particularly for de-hooking single barb fishing hooks from caught fish.

At its terminal end, the substantially straight end section 38 is bent at 42, away from the shank section 34, so as to define an outwardly diverging or flared end or terminal line guiding section 44 which permits the fishing line or the shank of a fishing hook to be guided into the narrow elongate gap 40 of the integral de-hooking element 24.

Operation:

When a fish has been caught, typically by a single barb fishing hook at the end of a fishing line, the fish on the line is oriented to hang substantially vertically with either hand of the user located within 6″ to 8″ above the fish and with the thumb of the user in the downward position and with the knuckles of the users hand facing toward the user. With the de-hooking device opened to its maximum extent, with the metal hook engaging element pivoted from the storage groove of the handle structure and to a position in substantial alignment with the handle structure, the operating end 35 is positioned substantially horizontally so that the sharply bent loop section of the de-hooking element, the flared guide section 44 and the narrow gap 40 are positioned substantially horizontally to receive the substantially vertically oriented fishing line.

The user will then orient the de-hooking device so that the metal de-hooking element is essentially horizontally oriented and will then pull in opposite directions on the de-hooking device and the fishing line, thus pulling the fishing line taut with a moderate pulling force. This pulling force causes the shank of the fish-hook to be drawn to the tightly bent loop, so that the loop moves onto the curvature of the hook to a location near the barb of the hook. At this point the user will apply a pulling force to the fishing line and to the de-hooking tool in opposed, generally horizontal directions, with the fish typically still hanging vertically from the fish hook. When these opposed pulling forces are applied, the fishing line will traverse the elongate slot 40 to the tightly bent U-shaped loop. Continued opposed pulling forces on the tool and fishing line will move the fishing line through the tightly bent loop and will cause the eye and shank of the fish hook to also be moved through the narrow gap or slot 40 to a point that the loop 36 comes into engagement with the curved throat of the fish hook to a point near the barb of the hook. With the de-hooking device and the fishing line thus held essentially horizontally, the fish is swung towards the user's body and over the essentially horizontally oriented fishing line and de-hooking device. The fish-hook, being forced by the tightly bent loop section of the de-hooking element, will be extracted from the fish during this flipping movement, so that it will either fall into a fish well of a boat or other receptacle, if the fish is intended to be kept, or will fall into the water for releasing of the fish, depending on the intentions of the user. In either case, the user's hands will not touch the fish during the handling and de-hooking operation, hence the survival rate of fish released in this manner will be significantly enhanced.

If the fish is hooked deeply, with the barb of the single barbed hook penetrating deeply into throat tissue of the fish, the considerable length of the U-shaped operating end 35 of the hook and line engaging element will be inserted deeply into the mouth and throat of the fish, with the tight U-shaped bend 36 engaging the curved throat of the hook at a point near the barb of the hook. Thus, when the fish is flipped free of the hook in the manner disclosed above, the barb will be extracted from the throat tissue, with minimal damage. If the fish is to be released, it will fall directly back into the water, without having been touched by the hands of the fisherman or by any of the other types of tools that are typically used for handling of fish.

After having used the fish de-hooking device in this manner, the de-hooking or line and hook engaging element shown generally at 33 will then be pivotally folded into the storage groove 22 of the handle structure 12. The D-ring or a lanyard then may be used to connect the de-hooking device to the belt or clothing of the user. Alternatively, if it is desired to secure the de-hooking device to the belt or clothing of the user, with the de-hooking element open to its extended position, as shown in FIG. 1, the operating end 35 of the integral de-hooking element may be hung over the waist belt or through a belt loop of the clothing of the user, with the waist belt or belt loop located within the narrow elongate gap 40.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A de-hooking device for releasing fish that have been caught by a fishhook that is connected to a fishing line, comprising:
a handle member adapted to be grasped by the hand of a user;
an integral de-hooking element extending from said handle member and having an elongate shank section of substantially straight configuration defining an operating end; said operating end having a tightly bent loop of U-shaped configuration and a substantially straight end section disposed in spaced relation with said elongate shank section and defining an elongate narrow gap therewith; and
a terminal section extending from said substantially straight end section and being oriented in outwardly diverging relation with said elongate shank section.

2. The de-hooking device of claim 1, comprising:
said integral de-hooking element being composed of metal and having an annular cross-sectional configuration.

3. The de-hooking device of claim 1, comprising:
said terminal section being of substantially straight configuration and having a bend with said substantially straight end section and being oriented by the bend to obtuse angular relation with said substantially straight end section.

4. The de-hooking device of claim 1, comprising:
said integral de-hooking element being pivotally connected with said handle member and being moveable from a closed position where said integral de-hooking element lies along said handle member and an open position where said integral de-hooking element is substantially aligned with said handle member.

5. The de-hooking device of claim 1, comprising:
said handle member defining a handle length and defining an elongate slot extending substantially along said handle length, said handle member further defining a pivot receptacle being oriented in substantially normal relation with said elongate slot;
a pivot end being defined by said elongate substantially straight shank of said integral de-hooking element and being located for pivotal movement within said elongate slot of said handle member, said pivot end defining a pivot opening; and
a pivot element extending through said pivot receptacle and said pivot opening and securing said integral de-hooking element in pivotal relation with said handle member and permitting pivotal movement of said integral de-hooking element from a closed position where a substantial portion of said integral de-hooking element is located within said elongate slot and a full open position where said integral de-hooking element is substantially fully exposed and is substantially aligned with said handle member.

6. The de-hooking device of claim 5, comprising:
said handle member being of integral construction.

7. The de-hooking device of claim 5, comprising:
said handle member having a pair of scales being disposed in spaced relation with said elongate slot located therebetween.

8. The de-hooking device of claim 5, comprising:
a plurality of ridges and depressions being defined by said handle member enabling efficient and secure gripping of said handle member by the hand of a user.

9. The de-hooking device of claim 5, comprising:
said pivot end being defined by a substantially circular pivot end portion of said integral de-hooking element having frictional engagement with surfaces of said elongate slot and resisting free pivotal movement of said integral de-hooking element relative to said elongate handle member.

10. The de-hooking device of claim 1, comprising:
said de-hooking device being buoyant in water.

11. A de-hooking device for releasing fish that have been caught by a fishhook that is connected to a fishing line, comprising:
a handle member adapted to be grasped by the hand of a user and defining an elongate storage slot;
an integral de-hooking element being in pivotal connection with said handle member and pivotal movement of said integral de-hooking element from a closed position where a substantial portion of said integral de-hooking element is located within said elongate slot and a full open position where said integral de-hooking element is substantially fully exposed and is substantially aligned with said handle member, said integral de-hooking element having an elongate shank section of substantially straight configuration defining an operating end; said operating end having a tightly bent loop of U-shaped configuration and a substantially straight end section disposed in spaced relation with said elongate shank section and defining an elongate narrow gap therewith; and
a terminal section extending from said substantially straight end section and being oriented in outwardly diverging relation with said elongate shank section.

12. The de-hooking device of claim 11, comprising:
said integral de-hooking element being composed of metal and having an annular cross-sectional configuration.

13. The de-hooking device of claim 11, comprising:
said terminal section being of substantially straight configuration and having a bend with said substantially straight end section and being oriented by the bend to obtuse angular relation with said substantially straight end section.

14. The de-hooking device of claim 11, comprising:
said handle member defining a pivot receptacle being oriented in substantially normal relation with said elongate slot;
a pivot end being defined by said elongate substantially straight shank of said integral de-hooking element and being located for pivotal movement within said elongate slot of said handle member, said pivot end defining a pivot opening; and
a pivot element extending through said pivot receptacle and said pivot opening and securing said integral de-hooking element in pivotal relation with said handle member and permitting pivotal movement of said integral de-hooking element from a closed position where a substantial portion of said integral de-hooking element is located within said elongate slot and a full open position where said integral de-hooking element is substantially fully exposed and is substantially aligned with said handle member.

15. The de-hooking device of claim 11, comprising:
said handle member being of integral construction.

16. The de-hooking device of claim 11, comprising:
said handle member having a pair of scales being disposed in spaced relation with said elongate slot located therebetween.

17. The de-hooking device of claim 11, comprising:
a plurality of ridges and depressions being defined by said handle member enabling efficient and secure gripping of said handle member by the hand of a user.

18. The de-hooking device of claim 11, comprising:
said pivot end being defined by a substantially circular pivot end portion of said integral de-hooking element having frictional engagement with surfaces of said elongate slot and resisting free pivotal movement of said integral de-hooking element relative to said elongate handle member.

19. The de-hooking device of claim 11, comprising:
said de-hooking device being buoyant in water.
